(19) United States
(12) Patent Application Publication
(10) Pub. No.: US 2012/0252545 A1
(43) Pub. Date: Oct. 4, 2012

(54) FIRST TO CLAIM LETTER WORD GAME

(76) Inventors: Ian Osborne, Gardena, CA (US); Elliot Rudell, Torrance, CA (US); George T. Foster, Placerville, CA (US); Julio Sandoval, Long Beach, CA (US)

(21) Appl. No.: 13/370,754

(22) Filed: Feb. 10, 2012

Related U.S. Application Data
(60) Provisional application No. 61/443,059, filed on Feb. 15, 2011.

(51) Int. Cl. A63F 3/00; A63F 13/00

(52) U.S. Cl. 463/9; 273/272

(57) ABSTRACT

A game that can be played by a plurality of players. The game includes a tile dispenser that contains a plurality of tiles that each have at least one letter indicia. The tile dispenser can dispense tiles in a manner so that each tile is claimed by one of the players. For example, when a tile is dispensed one of the players may yell “GOT IT” to claim a tile. The game also includes an organizing device that is adapted to organize words from the letter indicia of the dispensed tiles. For example, the organizing device may be a tray with compartments configured to hold a single tile. The game can be played by repeatedly dispensing, claiming and organizing tiles into words until all of the tiles are dispensed from the tile dispenser.

### CROSS-REFERENCE TO RELATED APPLICATIONS

This application claims priority to Application No. 61/443,059 filed on Feb. 15, 2011.

### BACKGROUND OF THE INVENTION

1. Field of the Invention

The present invention relates to a word game.

2. Prior Art

There are many word games on the market that utilize individual letter tiles that players select, or get dealt, and then place on a common game board to create words and score points. “SCRABBLE” is the classic word game, where players select tiles and then alternate turns placing the tiles they select on a common game board, scoring points per letter (more points for difficult letters) and then also scoring bonuses when a tile is placed on a special point-designation game space. “UPWORDS” is a letter tile game where players randomly pick letters and then play on a common game board, building words with tiles that have been randomly selected like SCRABBLE, but with the added play element of being able to stack the tiles one atop the other on the game board. UPWORDS allows players to modify words played on prior rounds, and score points relative to how many tiles have been stacked, in addition to scoring points for letters played. There are many variants of similar games.

There is a classic and old social game called “BINGO” wherein a dealer selects a marker with a number or letter on it, and calls out the number or letter to multiple game players, each player having their own game card that has letters or numbers pre-printed onto different sectors of the game card. When the dealer calls out a letter or number that a player or several players match on the their game card(s), those players each put a small marker onto that matching indicia. When a player has several indicia in a straight line on their card, they call out “BINGO!” to declare that they've completed their card, and won.

### BRIEF SUMMARY OF THE INVENTION

A game that can be played by a plurality of players. The game includes a tile dispenser that contains a plurality of tiles that each have at least one letter indicia. The tile dispenser can dispense tiles in a manner so that each dispensed tile can be claimed by one of the players. The game also includes an organizing device that is adapted to organize the letter indicia of the dispensed tiles into words.

### BRIEF DESCRIPTION OF THE DRAWINGS

FIG. 1 is an illustration of a game unit;

FIGS. 2A and 2B are an illustration of a game instruction sheet for the game unit;

FIG. 3 is an illustration showing an exploded view of a tile dispenser;

FIG. 4 is an illustration of an alternate embodiment of a game set that includes a tile dispenser bag, and a paper and pencil;

FIG. 5 is an illustration showing an electronic device that is used to perform the game play of the game set shown in FIG. 1; and,

FIG. 6 is an illustration similar to FIG. 5 showing a player “claiming” a letter.

### DETAILED DESCRIPTION

Disclosed is a game that can be played by a plurality of players. The game includes a tile dispenser that contains a plurality of tiles that each have at least one letter indicia. The tile dispenser can dispense tiles in a manner so that each tile is claimed by one of the players. For example, when a tile is dispensed one of the players may yell “GOT IT” to claim a tile. The game also includes individual player organizing devices adapted to organize words from the letter indicia of the dispensed tiles. For example, the organizing device may be a tray with compartments, each compartment is configured to hold a single tile. The game can be played by repeatedly dispensing, claiming and organizing tiles into words until all of the tiles are dispensed from the tile dispenser. Each letter may have the same point value, and players score points for each tile in a legal word. Alternatively, each letter may be worth a different predetermined point value. The points associated with letters formed in words can be added. Letter tiles held by a player that are not part of a legal word are subtracted from their total score. The player with the most points wins the game. Unlike BINGO or other similar games, the game described herein does not offer preprinted cards, but rather challenges one of many players to be the first and only player to acquire a letter tile as it becomes available, and then hurriedly place that tile onto their individual game board into a position that will eventually result in the successful creation of acceptable words.

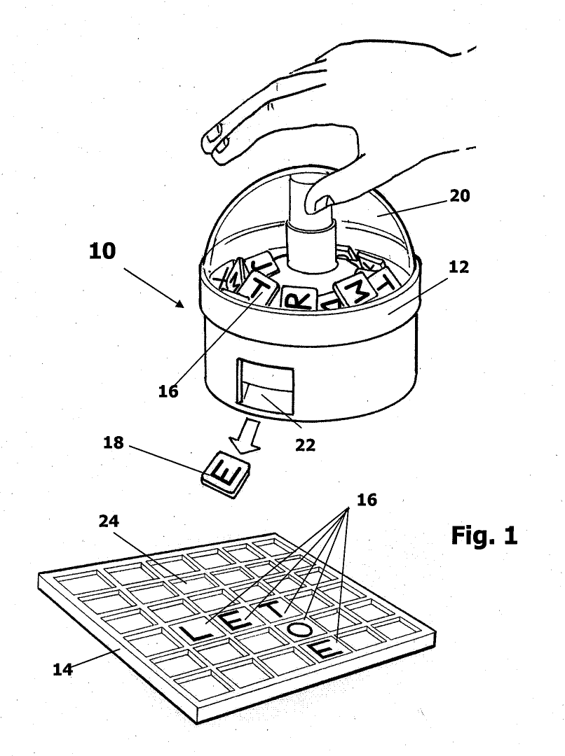

Referring to the drawings by reference numbers, FIG. 1 shows an embodiment of a game unit 10. The game unit 10 includes a tile dispenser 12 and an organizing device 14. The dispenser 12 includes a plurality of tiles 16. Each tile 16 has a letter indicia 18. A letter indicia 18 may preferably be located on both sides of each tile 16. The letters on each side of a tile 16 may be the same or different. Although not shown, a point value for each letter 18 may be formed or displayed onto each tile 16. The tile dispenser 12 may include a spring biased cover 20 that can be depressed by a player to dispense a tile through a dispenser opening 22. The organizing device 14 may be a tray with a plurality of compartments 24. Each compartment 24 may have dimensions that allow a single tile 16 to be placed therein in a manner so that each tile 16 is flush with the top surface of the tray, thereby discouraging their removal or replacement during the game.

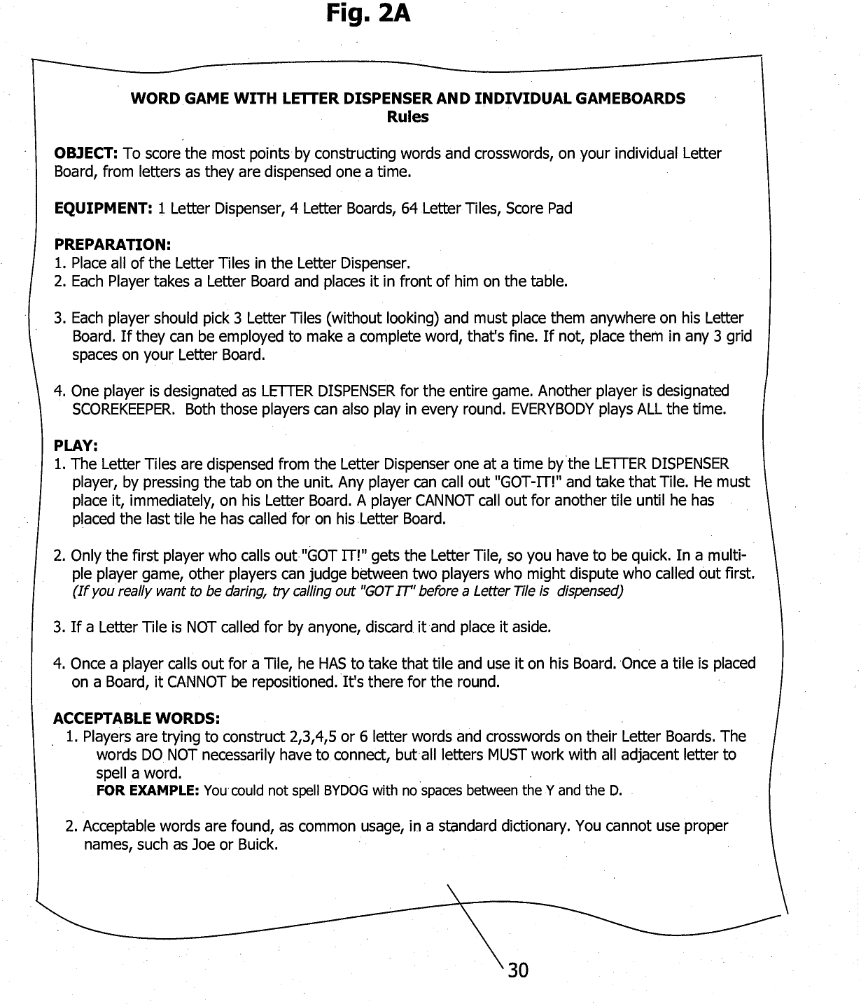

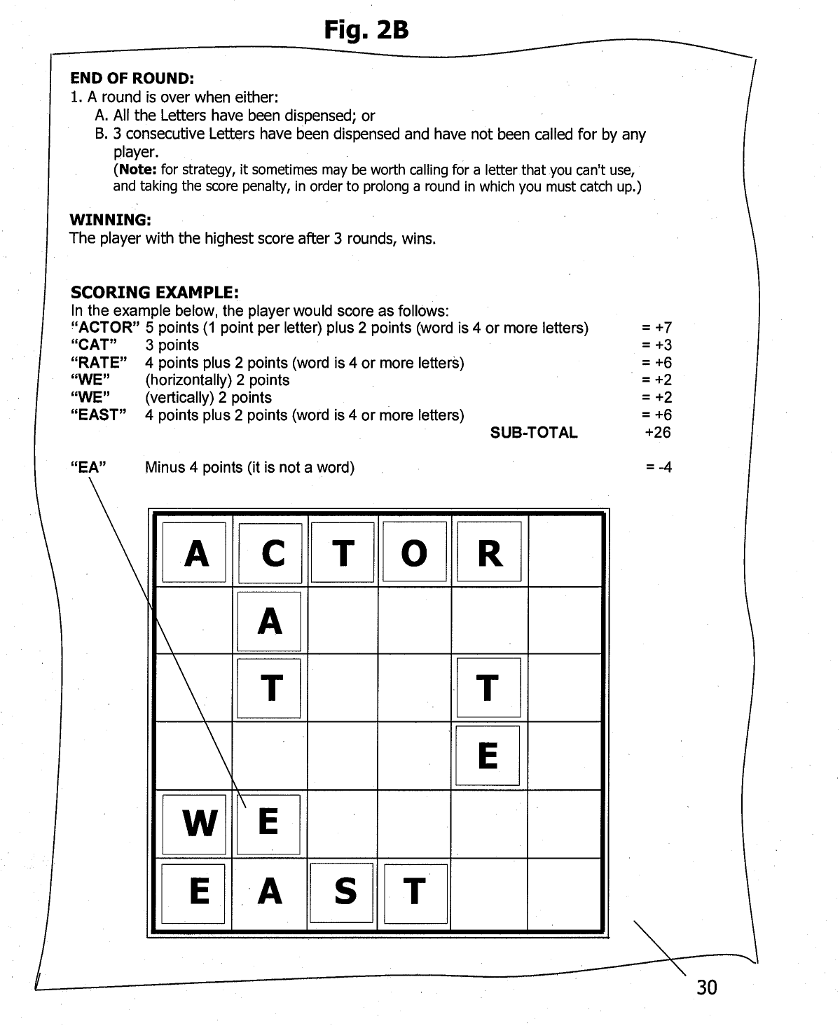

The game set 10 may be provided with game instructions 30 shown in FIG. 2A and FIG. 2B. The game instructions 30 provide instructions on how to play a game with the game set 10. In accordance with the instructions, the tiles 16 can be dispensed from the dispenser 12 one at a time in a sequential manner. Each time a tile 16 is dispensed any player may be the first to claim the tile 16. By way of example, a player may yell “GOT IT”. The player who claims the tile may use the letter indicia to form a word in their tray. The process of dispensing, claiming and organizing tiles into words is repeated until all of the tiles 16 are dispensed from the tile dispenser 12, or until several tiles are dispensed, in a row, without being claimed. Each player then adds up the points associated with tiles formed in a legal word(s), and subtracts points for tiles not used properly in a word(s). The player with the most points wins the game. Unlike word games of the prior art, the dispensing, claiming and necessary rapid positioning of tiles in this invention adds an element of urgency and excitement in deciding when to claim and where to position a tile, because tiles that are not used to form legal words are subtracted from a players score.

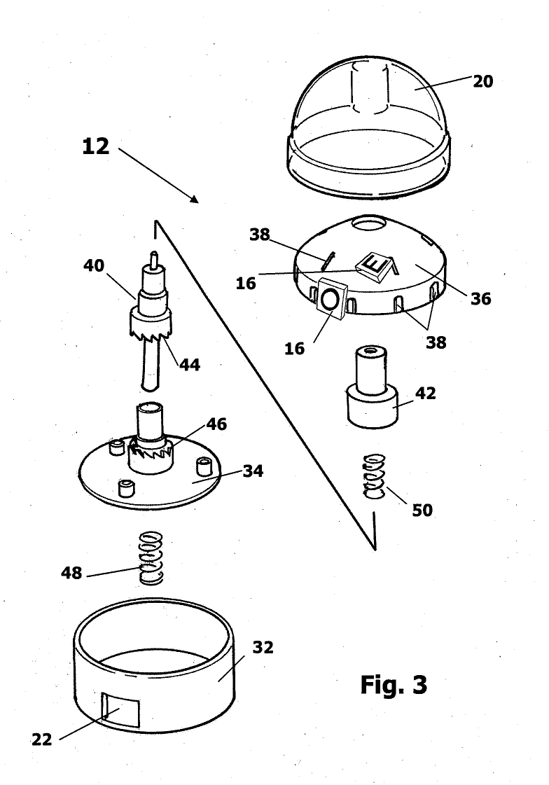

FIG. 3 shows an embodiment of a tile dispenser 12 with the cover 20. The dispenser 12 includes a lower housing 32 that has dispenser opening 22. Within the housing 32 are a lower tile platform 34 and an upper tile platform 36. The upper tile platform 36 has a plurality of raised boss features 38. The platforms 34 and 36 are coupled together by a ratchet shaft 40 and a spacer 42. The ratchet shaft 40 has ratchet teeth 44 that cooperate with ratchet teeth 46 of the lower platform 34. The dispenser 12 may further have a pair of springs 48 and 50.

In operation, a user pushes down on the tile dispenser cover 20. Movement of the cover 20 causes a downward movement of the upper tile platform 34 and the mating of the ratchet teeth 44 and 46. The mating of the ratchet teeth 44 and 46 induces a rotation of the upper tile platform 36. The boss features 38 engage the tiles 16 and force one of the tiles 16 to be dispensed through the opening 22. Although a manually actuated tile dispenser is shown and described, it is to be understood that the dispenser may include a motor that can be activated to dispense a tile.

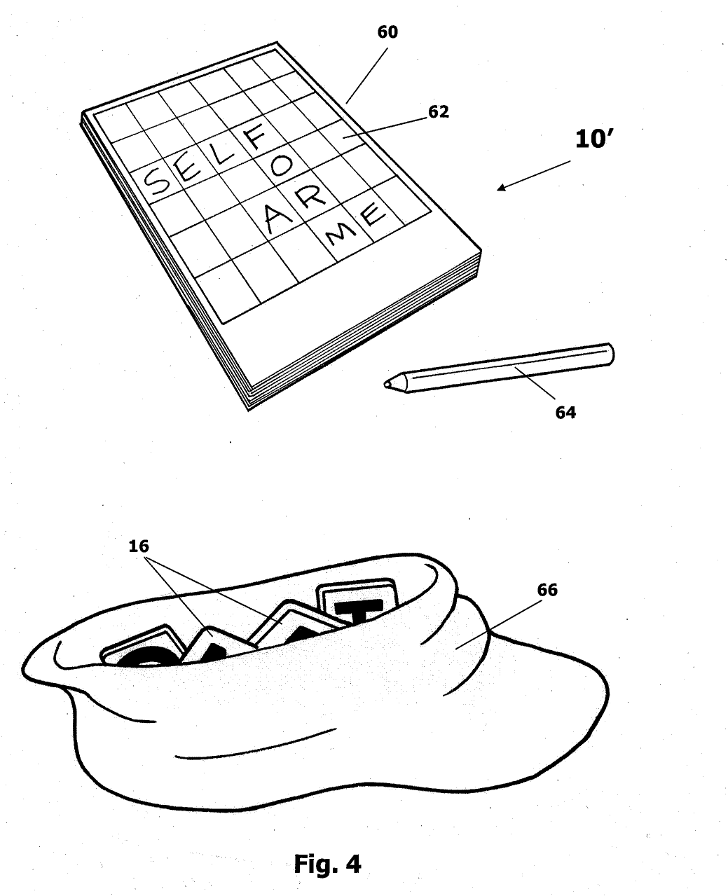

FIG. 4 shows another embodiment of the game set 10′. Instead of a tray the organizing device may include a pad of paper 60 with printed squares 62 and a pencil or pen 64. The letters associated with claimed tiles may be written into the squares 62 to form words. The tile dispenser may be a bag 66 filled with tiles. A “dealer” player can remove one tile at a time from the bag 66, wherein any player can then claim the tile. The player that has claimed the tile can then write the letter indicia onto the paper to form a word(s). Although an embodiment with a bag dispenser and paper is shown and described, the game set may include the paper organizer in FIG. 4 with the tile dispenser shown in FIG. 1, or the bag shown in FIG. 4 with the tray shown in FIG. 1.

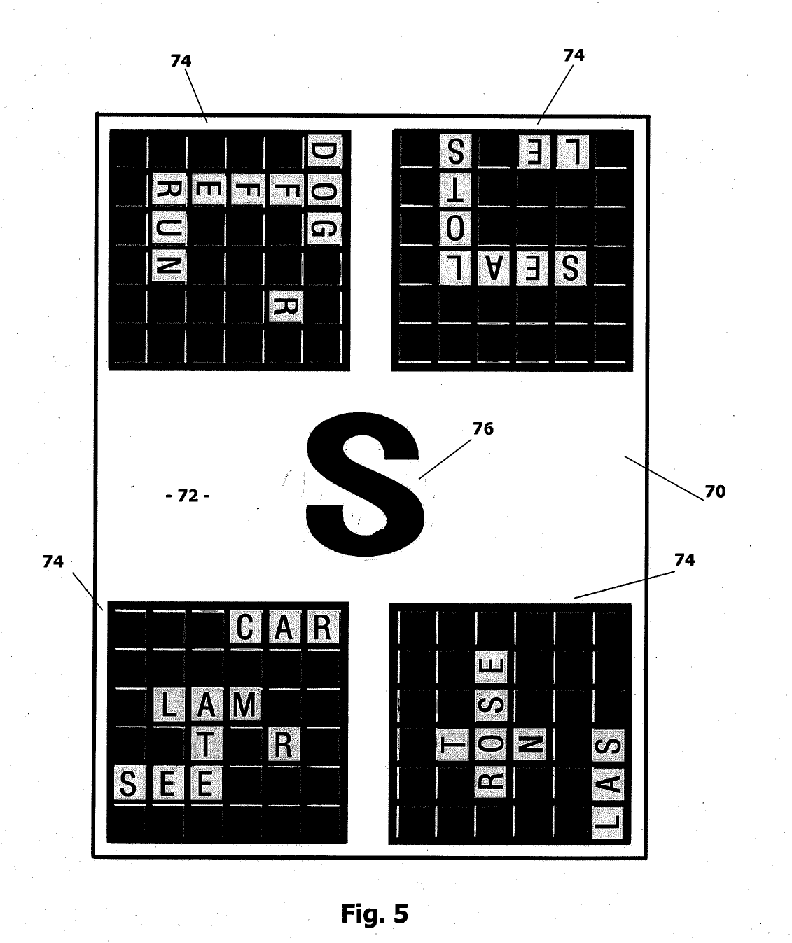

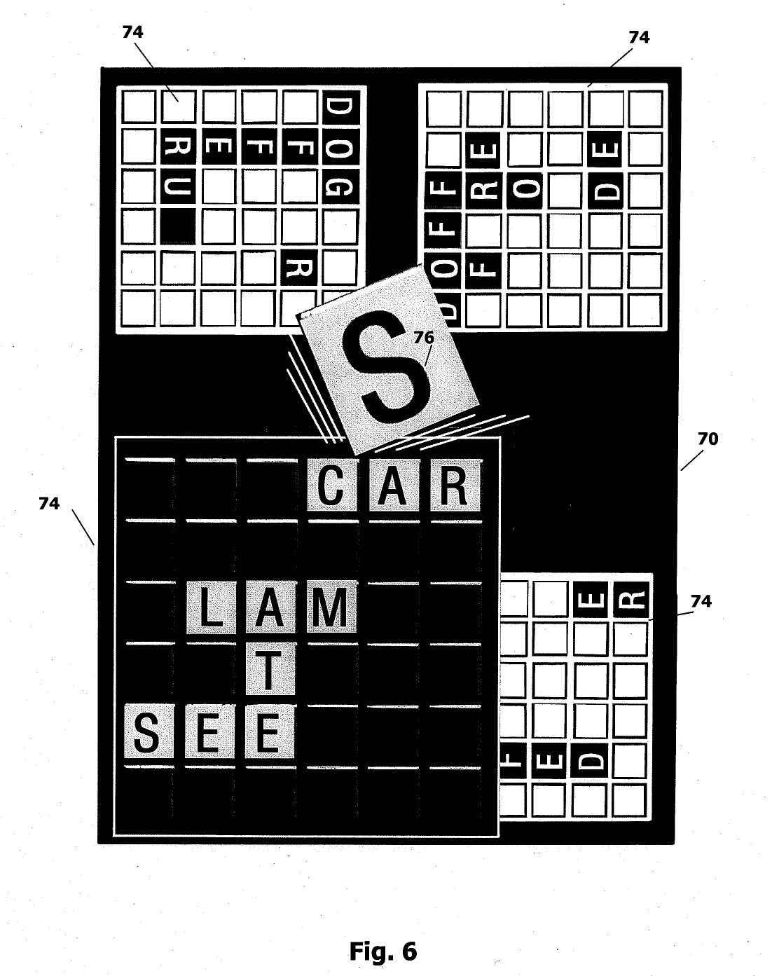

FIGS. 5 and 6 show an electronic device 70 that can be used to perform the game play associated with the game set shown in FIG. 1. The device 70 may include a display surface 72 such as an LCD touch screen. The device 70 may be a hand held device such as an Apple iPad. As is known in the art such devices include memory, a processor and other associated circuits. Additionally, such devices include firmware and software with instructions that are executed by the processor to perform applications. The software of the device 70 may cause the display surface 72 to display a plurality of play surfaces 74 and a letter 76. Each play surface 74 may depict squares, and letters that have been positioned by a player to form words. In operation, a letter 76 may be displayed and a player can claim the letter. By way of example, a player may claim a letter by touching the location of the letter on the touch sensitive display surface 72. The player can then drag the letter onto their play surface 74 to form a word. A new letter is then displayed in the center of the display surface 72 and the process is repeated. Once a player has touched his game play surface 74 to claim a displayed letter 76, that player's game board graphic can magnify as shown in FIG. 6, and a set period of time can be counted down, during which time that player must touch and move the selected letter 76 into position on his game board screen 74 to form a legal word, or start a new legal word.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A game unit that can be played by a plurality of players, comprising:
a tile dispenser that contains a plurality of tiles that each have at least one letter indicia, said tile dispenser can be operated to dispense said tiles in a manner so that each dispensed tile can be claimed by one of the players; and,
an organizing device that is adapted to organize words from the letter indicia of the dispensed tiles.

2. The game unit of claim 1, wherein said tile dispenser includes a spring biased element that can be depressed to dispense one of said tiles.

3. The game unit of claim 1, wherein said organizing device includes a tray with a plurality of compartments each adapted to receive one of said tiles.

4. The game unit of claim 3, wherein said organizing device includes a plurality of trays, each player having their own tray and each tray having a plurality of compartments each adapted to receive one of said tiles.

5. The game unit of claim 1, wherein said dispenser includes a motor.

6. A method for playing a game by a plurality of players, comprising:
providing a tile dispenser that contains a plurality of tiles, each tile having at least one letter indicia;
dispensing at least one tile;
claiming the tile by one of the players;
organizing the letter indicia with letter indicia of other tiles to form words; and
repeating the steps of dispensing and claiming tiles and organizing the letter indicia to form words.

7. The method of claim 6, wherein the tiles are placed into compartments of a tray to organize the letter indicia into words.

8. The method of claim 6, wherein the tiles are placed into compartments of a plurality of trays, each player having one of the trays.

9. The method of claim 6, wherein the tiles are dispensed by pushing a spring biased element of the dispenser.

10. An electronic device that can be played by a plurality of players, comprising:
a display surface;
a processor that is coupled to said display and causes the display of a plurality of game play areas for the players, and the sequential display of letters; and,
an input device that allows a player to select a displayed letter and organize displayed letters into words in their corresponding play area.

11. The electronic device of claim 9, wherein said input device is a touch screen function of said display surface.

12. A non-transitory computer program that causes an electronic device to be played by a plurality of players, comprising:
a non-transitory computer storage medium that contains a computer program that causes a processor to the display a plurality of game play areas for the players and sequential display letters on a display surface, and further causes said processor to process input from the players to claim said displayed letters and organize said claimed displayed letters into words in said corresponding play areas.

13. The non-transitory computer program of claim 11, wherein said input is provided by a touch screen function of said display surface.
